(19) United States
(12) Patent Application Publication
(10) Pub. No.: US 2025/0150128 A1
(43) Pub. Date: May 8, 2025

(54) COMMUNICATION APPARATUS AND COMMUNICATION METHOD FOR REDUCED DIMENSION CSI FEEDBACK

(71) Applicant: Panasonic Intellectual Property Corporation of America, Torrance, CA (US)

(72) Inventors: Rajat PUSHKARNA, Singapore (SG); Rojan CHITRAKAR, Singapore (SG); Hiroyuki MOTOZUKA, Kanagawa (JP); Yoshio URABE, Nara (JP)

(21) Appl. No.: 18/836,668

(22) PCT Filed: Jan. 5, 2023
(86) PCT No.: PCT/SG2023/050009

§ 371 Date: Aug. 7, 2024

(30) Foreign Application Priority Data
Feb. 9, 2022 (SG) 10202201250Q

(51) Int. Cl. H04B 7/06; H04B 17/309

(52) U.S. Cl. CPC H04B 7/0608; H04B 7/0626; H04B 17/346

(57) ABSTRACT

Communication devices and methods for reduced dimension CSI feedback are provided. One exemplary embodiment provides a first communication apparatus comprising a receiver, which in operation, receives a PPDU from a second communication apparatus: circuitry, which in operation, measures CSI based on the PPDU, and selects a first subset of elements from a plurality of elements of a CSI matrix, wherein each element represents the CSI measured at a receive antenna of the first communication apparatus corresponding to a transmit antenna of the second communication apparatus; and a transmitter, which, in operation, transmits a frame reporting the selected subset of elements to the second communication apparatus.

### BACKGROUND

### 1. Technical Field

The present embodiments generally relate to communication apparatuses, and more particularly relate to methods and apparatuses for reduced dimension channel state information (CSI) feedback.

### 2. Description of the Related Art

In the standardization of next generation wireless local area network (WLAN), new technology to enable wireless sensing utilizing IEEE 802.11 technologies has been discussed in the 802.11 Working Group and is named 802.11bf WLAN SENS.

IEEE 802.11 defines three types of channel sounding feedback, namely channel state information (CSI) matrices feedback (as described in 11n, wherein a beamformer receives a quantized MIMO channel matrix, Heff, from a beamformee), non-compressed beamforming feedback matrix (as described in 11n, wherein beamforming feedback matrices, V, found by a beamformee are sent to a beamformer), and compressed beamforming feedback matrix (as described in 11n, 11ac and 11ax, wherein beamforming feedback matrices, V, found by a beamformee are compressed in the form of angles (Y (Psi) and @ (Phi)), which are sent to a beamformer). Referring to example illustration 100 of FIG. 1, feedback response 108 from a beamformee 104 to a beamformer 102 may have one of three formats:
CSI: Beamformee 104 sends the MIMO channel coefficients to beamformer 102.
Noncompressed beamforming: Beamformee 104 sends calculated beamforming feedback matrices to beamformer 102.
Compressed beamforming: Beamformee 104 sends compressed beamforming feedback matrices to beamformer 102.

In 11bf SFD [1], it is agreed that CSI (that is, the channel measured during the training symbols of a received PPDU) is a type of sensing measurement result for sub-7 GHZ WLAN sensing. To enable sub-7 GHZ WLAN sensing, an RXVECTOR parameter CSI_ESTIMATE is defined that contains the channel measured during the training symbols of the received PPDU. The format of CSI_ESTIMATE is the same one used in a measurement report field within a Sensing Measurement Report frame. A Sensing Measurement Report frame, which allows a sensing receiver to report sensing measurements, is also defined. This frame contains at least a measurement report control field which contains information necessary to interpret the measurement report field, or a measurement report field which carries CSI measurements obtained by a sensing receiver.

As can be seen from table 200 of FIG. 2A (i.e. depicting Table 9-56—CSI Report field (20 MHz) in 802.11n), the CSI Report format used in 802.11n to carry CSI feedback is such that the CSI matrix for each reported subcarrier requires (3+2*Nb*Nc*Nr) bits. 3 bits/carrier is for Carrier Matrix Amplitude (or the scaling ratio per subcarrier MH (k)), and there is one I and one Q value per subcarrier. Table 202 of FIG. 2A illustrates the meaning and range of values for each CSI field parameter, in particular that Nb refers to number of bits determined by the Coefficient Size field of the MIMO Control field, Nc refers to number of columns in a CSI matrix, and Nr refers to number of rows in a CSI matrix.

The CSI matrix comprise of dimensions which are equal to Nr×Nc and may not be required for WLAN sensing use cases causing an overhead to the WLAN communication.

There is thus a need for communication apparatuses and methods that can solve the above-mentioned issue. Furthermore, other desirable features and characteristics will become apparent from the subsequent detailed description and the appended claims, taken in conjunction with the accompanying drawings and this background of the disclosure.

### SUMMARY

Non-limiting and exemplary embodiments facilitate providing communication apparatuses and communication methods for reduced dimension CSI feedback.

According to an aspect of the present disclosure, there is provided a first communication apparatus comprising: a receiver, which in operation, receives a physical layer protocol data unit (PPDU) from a second communication apparatus; circuitry, which in operation, measures channel state information (CSI) based on the PPDU, and selects a first subset of elements from a plurality of elements of a CSI matrix, wherein each element represents the CSI measured at a receive antenna of the first communication apparatus corresponding to a transmit antenna of the second communication apparatus; and a transmitter, which, in operation, transmits a frame reporting the selected subset of elements to the second communication apparatus.

According to another aspect of the present disclosure, there is provided a second communication apparatus, comprising: circuitry, which in operation, generates a frame indicating a subset of elements of a CSI matrix for which CSI is solicited; and a transmitter, which in operation, transmits the frame to a first communication apparatus.

According to another aspect of the present disclosure, there is provided a second communication apparatus, comprising: circuitry, which in operation, generates a frame indicating a subset of elements of a CSI matrix for which a component of the CSI matrix is solicited; and a transmitter, which in operation, transmits the frame to a first communication apparatus.

According to another aspect of the present disclosure, there is provided a communication method comprising: receiving a physical layer protocol data unit (PPDU); measuring channel state information (CSI) based on the PPDU, and selecting a subset of elements from a plurality of elements of a CSI matrix based on the measured CSI, wherein each element represents the CSI measured at a receive antenna of a first communication apparatus corresponding to a transmit antenna of a second communication apparatus and transmitting a frame reporting the selected subset of elements.

It should be noted that general or specific embodiments may be implemented as a system, a method, an integrated circuit, a computer program, a storage medium, or any selective combination thereof. Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

The accompanying figures where like reference numerals refer to identical or functionally similar elements throughout the separate views and which together with the detailed description below are incorporated in and form part of the specification, serve to illustrate various embodiments and to explain various principles and advantages in accordance with present embodiments.

FIG. 1 depicts an example illustration of a 802.11n explicit transmit beamforming feedback sequence.

FIG. 2A depicts a table for 20 MHz CSI Report field according to an example.

FIG. 2B depicts a table for CSI field parameters according to an example.

FIG. 3 depicts a table describing subfields Nc index and Nr index for high efficiency multiple-input-multiple-output (HE MIMO) control field encoding according to an example.

FIG. 4A depicts an example illustration of beamforming feedback in spatial domain.

FIG. 4B depicts an example illustration of CSI from different antennas of a same device.

FIG. 5 depicts an example illustration of WLAN sensing frame exchange depicting CSI feedback from a responder to an initiator.

FIG. 6 depicts an example illustration of CSI across subcarriers from different antennas of a same device according to an embodiment E1.

FIG. 7 depicts an example flowchart of how an antenna may be selected and reported according to an embodiment E1.

FIG. 8 depicts an example illustration of delayed reporting according to an embodiment E1.

FIG. 9 depicts an example illustration of a sensing measurement report frame according to an embodiment E1.

FIG. 10 depicts an example illustration of an alternative Nr index subfield providing antennas bitmap indication according to an embodiment E1.

FIG. 11 depicts an example table showing feedback reduction when reporting antennas of interest according to an embodiment E1.

FIG. 12 depicts an example illustration of soliciting CSI feedback from a responder by an initiator according to an embodiment E2.

FIG. 13 depicts an example flowchart of an antenna selection procedure according to an embodiment E2.

FIG. 14 depicts an example illustration of a sensing null data packet (NDP) announcement frame according to an embodiment E2.

FIG. 15 depicts an alternative illustration of a sensing NDP announcement frame according to an embodiment E2.

FIG. 16 depicts an example illustration of a sensing session setup according to an embodiment E2.

FIG. 17 depicts an example illustration of a sensing session setup request and response frame according to an embodiment E2.

FIG. 18 depicts an example illustration of a sensing measurement setup according to an embodiment E2.

FIG. 19 depicts an example illustration of a sensing measurement setup request and response frame according to an embodiment E2.

FIG. 20A shows example graphs depicting CSI from 3 different antennas of a receiver according to an embodiment E3-1.

FIG. 20B shows an example graph depicting division operation applied to CSI from first and second antennas as shown in FIG. 20A according to an embodiment E3-1.

FIG. 21 depicts an example illustration of how CSI ratio may be compared according to an embodiment E3-1.

FIG. 22 shows an example graph depicting presence detection using CSI phase difference according to an embodiment E3-2.

FIG. 23 depicts an example illustration of a measurement setup procedure for CSI ratio or difference according to an embodiment E3-2.

FIG. 24 depicts an example illustration of a sensing measurement setup request and response frame according to an embodiment E3-2.

FIG. 25 depicts an example illustration of a sensing measurement setup procedure according to an embodiment E4.

FIG. 26 depicts an example illustration of a trigger-based sensing measurement setup procedure according to an embodiment E5.

FIG. 27 shows an example table depicting MLME-TB-Sensing.request ( ) parameters according to an embodiment E5.

FIG. 28 shows an example table depicting MLME-TB-Sensing.confirm ( ) parameters according to an embodiment E5.

FIG. 29 depicts an example illustration of a single-input-single-output (SISO) system according to an embodiment E6.

FIG. 30 depicts a schematic diagram for a responder in accordance with various embodiments.

FIG. 31 depicts a schematic diagram for an initiator in accordance with various embodiments.

FIG. 32 shows a flow diagram illustrating a method for reduced dimension CSI feedback according to various embodiments.

FIG. 33 shows a schematic, partially sectioned view of a STA that can be implemented for reduced dimension CSI feedback in accordance with various embodiments.

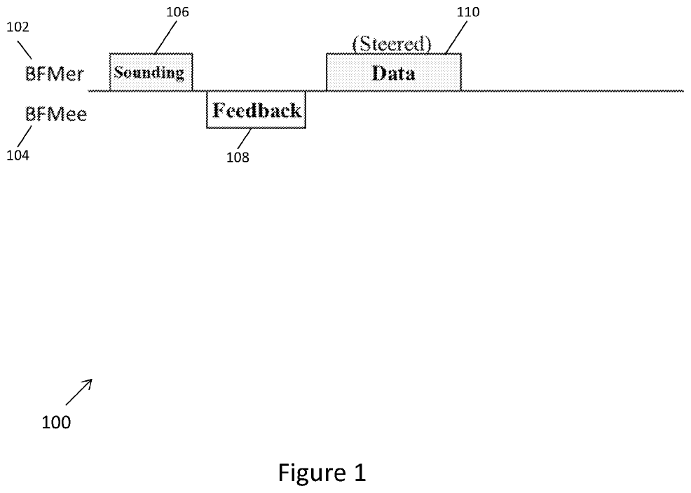

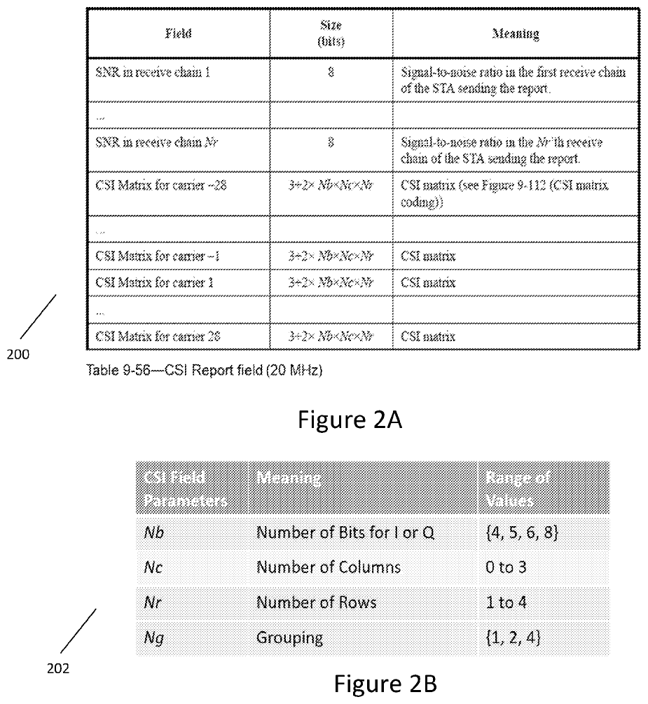

Skilled artisans will appreciate that elements in the figures are illustrated for simplicity and clarity and have not necessarily been depicted to scale.

### DETAILED DESCRIPTION

The following detailed description is merely exemplary in nature and is not intended to limit the embodiments or the application and uses of the embodiments. Furthermore, there is no intention to be bound by any theory presented in the preceding Background or this Detailed Description. Furthermore, other desirable features and characteristics will become apparent from the subsequent detailed description and the appended claims, taken in conjunction with the accompanying drawings and this background of the disclosure.

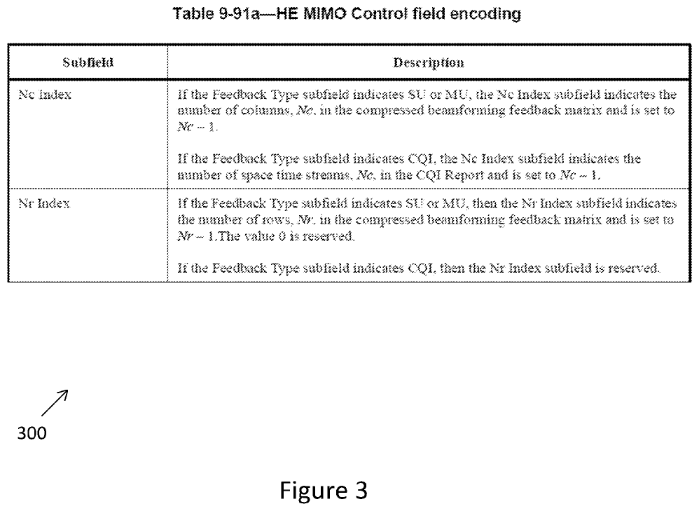

The dimension of beamforming feedback report format is based on Nc and Nr indices in, for example, a HE MIMO Control Field. Referring to table 300 of FIG. 3, the Nc index is indicated in the null data packet (NDP) announcement frame following two rules: if the NDP announcement frame has more than one STA Info field, the Nc subfield indicates the number of columns, Nc, in the compressed beamforming feedback matrix and is set to Nc−1 for MU case; if the NDP announcement frame is individually addressed, the Nc subfield value is reserved. The Nr and Nc are the number of rows and number of columns of the CSI matrix respectively. Nr is the number of rows which corresponds to number of receive chains and Nc is the number of columns which corresponds to the number of transmit space time streams.

802.11 specs states that the beamformer transmits an NDP with N_{STS,NDP} space-time streams, where N_{STS,NDP} takes value between 2 and 8. The beamformee upon receiving this NDP estimates the N_{RX,BFEE}×N_{STS,NDP} channel, and determines the Nr×Nc orthonormal matrix V. However, for WLAN Sensing it is possible that an NDP with N_{STS,NDP}=1 can be used for sensing, which is currently not allowed in the standards. For WLAN Sensing, SISO is a viable option to perform sensing, hence use of N_{STS,NDP}=1 should be included in the 11bf amendment.

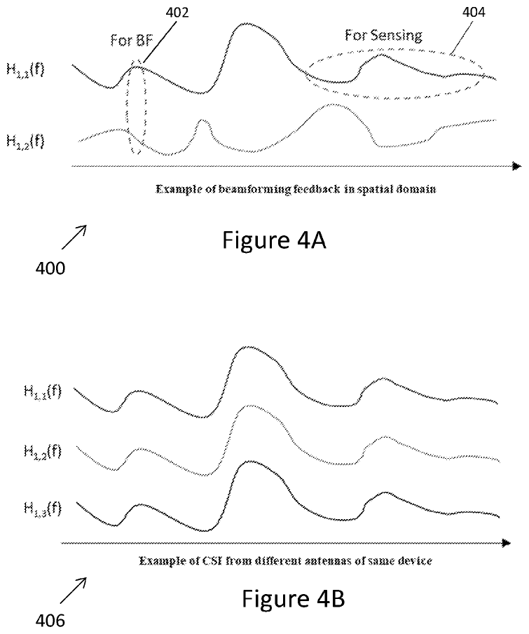

Referring to example illustration 400 of FIG. 4A of beamforming feedback in spatial domain for example, beamforming requires feedback in spatial domain (e.g. portion 402) but for sensing only a single antenna over time (e.g. portion 404) is sufficient. Further referring to example illustration 406 of FIG. 4B of CSI from different antennas of a same device, it can be seen from the CSI feedback that the 3 antennas of a device have similar CSI pattern, therefore the channel can be estimated even if only 1 of the 3 antennas' CSI is reported.

It is observed in MIMO systems that some antennas of a device may have similar CSI. Having a CSI feedback matrix with CSI from all antennas where CSI patterns are similar will result in overhead. It is therefore an objective of the present disclosure to reduce the overhead of CSI feedback, and propose related signaling (e.g. frame formats, CSI feedback report format).

As observed in illustration 406, there seems to be correlation in CSI data of the different antennas of same device. Therefore, it is possible to report reduced CSI for sensing application in various scenarios like, presence detection etc. Reduced CSI means reporting CSI of selective antenna pairs of a device. Although it is arguable that omitting information from CSI there is a lack of information of some spatial dimension but it may help in overhead reduction in various scenarios where complete information of all spatial dimension is not required. For example, periodic sensing of stationary receiver like in industrial scenario or empty room detection. 11bf may define reporting of Reduced Dimension CSI feedback to reduce overhead on the regular WiFi traffic.

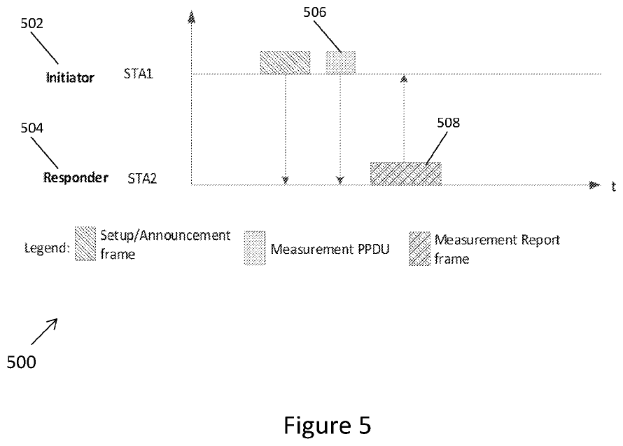

FIG. 5 depicts an example illustration 500 of CSI feedback from a responder station (STA) 504 to an initiator STA 502. The responder STA 504 which may be considered as a first communication apparatus receives a physical layer protocol data unit (PPDU) (e.g., a measurement PPDU such as an NDP) 506 that is used to perform channel measurements from the initiator STA 502 which may be considered as a second communication apparatus. The responder STA 504 obtains CSI from all antennas (e.g. based on the received PPDU) and selects antennas of interest for which CSI will be reported. The responder STA 504 then feedbacks CSI from antennas of interest as reduced dimension CSI feedback, for example by transmitting a measurement report frame 508. Reduced dimension CSI feedback may refer to reporting of CSI from selected antennas of interest to reduce Nr or Nc (e.g. number of rows or number of columns) of the CSI matrix, wherein the antennas of interest are selected based on comparing CSI values of different antennas and selecting antennas for which the CSI values vary more than a threshold. Reduced dimension CSI feedback may also refer to reporting of CSI by reducing Nc or Nr (e.g. number of columns or number of rows) of the CSI matrix. Thus, after measuring CSI based on the received PPDU, the Responder STA 504 may select a subset of elements from a plurality of elements of a CSI matrix based on the measured CSI, each element being one of a row or a column of the CSI matrix. Based on the selected Nr and Nc, the measurement report frame 508 shall report only for receive chains which are of interest. The Responder STA 504 may then transmit a frame reporting the selected subset of elements to the initiator STA 502.

In an embodiment E1, during the sensing measurement instances, a sensing initiator may transmit one or more sensing null data packet announcement (NDPA) and sensing measurement PPDU that is to be used by a sensing responder to perform sensing measurements. The sensing responder may receive the sensing NDPA and the sensing measurement PPDU and perform sensing measurements to obtain CSI. The sensing responder then chooses a reference antenna (for example, an antenna with highest signal noise ratio (SNR)) and its respective CSI as reference CSI. The sensing responder then selects one or more antennas which it wants to report by comparing the variation in CSI values from other antennas with the reference antenna's CSI values. The antennas are reported if the CSI variation from the antenna crosses a threshold. The threshold can be application specific and set on a receiver device by a user, or a responder may choose a threshold value based on CSI from all antennas. Each CSI matrix can be measured, determined on each subcarrier (also known as tone in 802.11); the CSI matrix on a tone consists of many elements (Nr×Nc elements, each element consisting of I and Q components (or amplitude and phase components)). A receive antenna may also be known as a receiver chain or a row or an element in the channel matrix. The reference antenna may also be known as the reference element in the channel matrix.

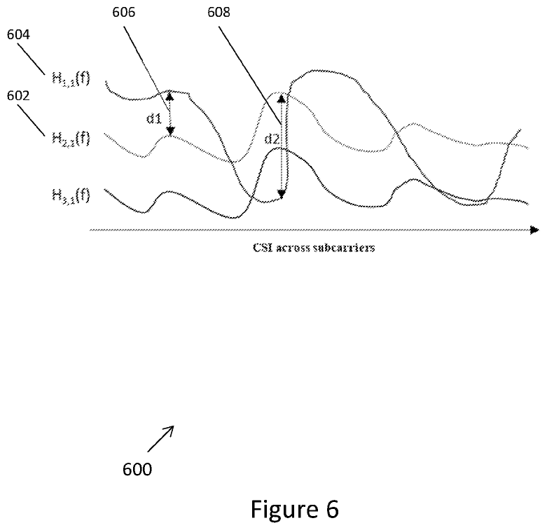

Referring to illustration 600 of FIG. 6, H2,1(f) 602 is the reference antenna's 5 CSI. Comparing the CSI values across subcarriers with, for example, H1,1(f) 604 will result in significant variation. Hence, the antenna associated with H1,1(f) 604 will be reported. For example, the sensing responder selects a reference antenna and it's CSI values as reference CSI values (H2,1(f)) 602. The sensing responder calculates the distance between two CSI values for each subcarrier for every antenna, for example distance d1 606 and distance d2 608. The sensing responder sets a threshold, and if the distance crosses the threshold for half of the subcarriers, the antenna will be reported. The threshold may be a value to represent the degree of variance between the CSI of the reference antenna and the CSI of the other antennas. Alternatively, the threshold may be a threshold CSI value that is set based on the reference antenna or element. Distance d may be represented in the form of equation d=|z2−z1|=\sqrt{(x2−x1) 2+ (y2−y1)2}, wherein x1, y1 are real and imaginary parts of z1 and x2 and y2 are real and imaginary parts of z2 respectively. This will be computed for all the subcarriers for a given antenna. If it is determined that d>threshold for half of the subcarrier (for example, like 23 for 20 MHz), the associated antenna will be reported. In this manner, CSI value of each element excluding the reference element in the plurality of elements in the CSI matrix may be computed and compared with the threshold CSI value, and a subset of elements may be selected based on the comparison (e.g. when each element in the selected subset of elements has a CSI value that is higher than that of the threshold CSI value) for reporting. Further, if no element has a CSI value that crosses the threshold CSI value based on the comparison, only CSI values of the reference antenna or element may be reported. It will be appreciated that the sensitivity of antenna reporting can be application specific and the threshold for reporting can be adjusted based on application requirements.

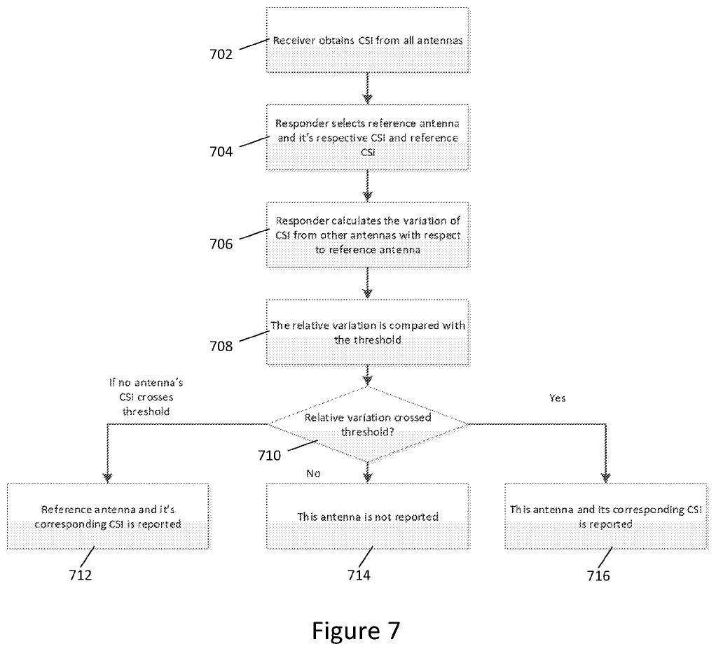

FIG. 7 depicts an example flowchart of how an antenna may be selected and reported according to embodiment E1. At step 702, a receiver obtains CSI from all antennas. At step 704, a responder selects a reference antenna and sets its respective CSI as reference CSI. At step 706, the responder calculates the variation of CSI from other antennas with respect to the reference CSI of the reference antenna. At step 708, the relative variation is compared with a threshold. At step 710, it is determined if the relative variation crossed the threshold. If it is determined to be the case, the process proceeds to step 716 wherein the antenna and its corresponding CSI is reported. Otherwise, the process proceeds to step 714 wherein the antenna is not reported. Steps 706 to 716 may be repeated for each receive antenna. If it is determined that no antennas' CSI crossed the threshold, the process proceeds to step 712 wherein the reference antenna and its corresponding CSI is reported.

A responder may perform steps 702 to 716 over transmit antennas (spatial streams.) In step 704, the responder selects a reference transmit antenna based on the CSI. The responder may calculate an SNR of a transmit antenna by averaging the SNRs of elements in CSI matrix over the transmit antenna (i.e. averaging the SNR over the column of the CSI matrix where the column is correspond to the transmit antenna.). (Alternatively) The responder may calculate an SNR of a transmit antenna based on a post processing SNR per spatial streams (i.e. SNR measured at the output of a MIMO detector or equalizer.). The responder may repeat steps 706 to 716 for each transmit antenna.

A responder may perform steps 702 to 716 over combinations of transmit and receive antennas (i.e. elements in CSI matrix that may be referred to as Tx-Rx links.) In step 704, the responder selects a reference antenna combination based on the CSI. The responder may calculate an SNR of an element by calculating the signal power by squaring the amplitude of the element which is divided by the noise power. The responder may repeat steps 706 to 716 for each combination of transmit and receive antennas.

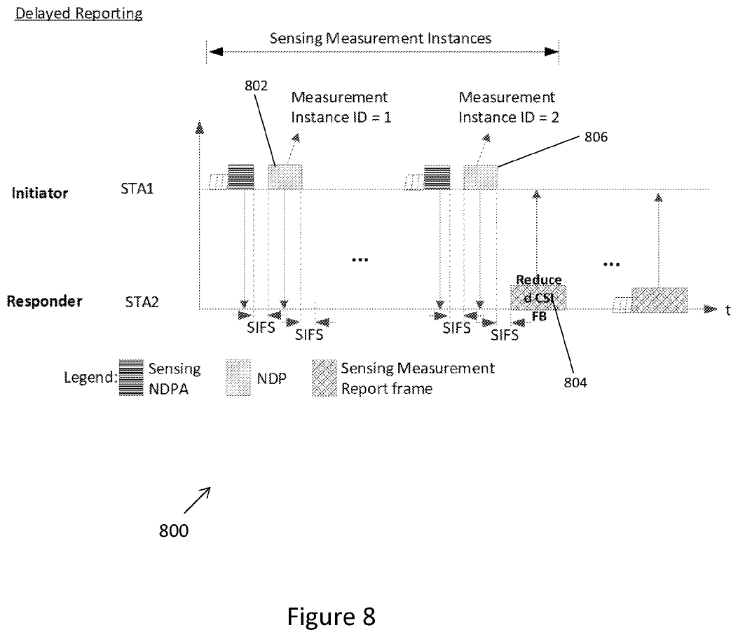

FIG. 8 depicts an example illustration 800 of delayed reporting according to embodiment E1. When supported or allowed, it is also possible that a sensing measurement report frame 804 carrying a CSI, amplitude or phase feedback for a measurement instance is not required to be transmitted immediately (e.g. after a short interframe space (SIFS)) after reception of a corresponding NDP 802, but may be transmitted after a delay (e.g., at a SIFS after receiving the NDP 806 for a next measurement instance, or even in the responder's own transmission opportunity (TXOP)). The maximum reporting delay i.e., the maximum time allowed between reception of a measurement PPDU (i.e., NDP) and transmission of a corresponding measurement report frame may also be negotiated during a sensing session setup and indicated using the Maximum Report Delay field in the Sensing Session Setup Request/Response frames.

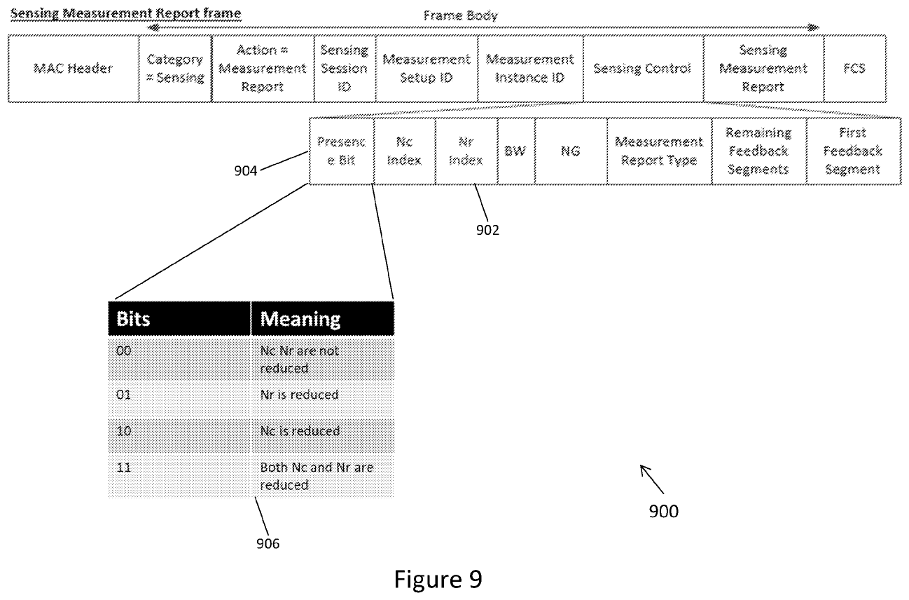

FIG. 9 depicts an example illustration of a sensing measurement report frame 900 according to embodiment E1. A responder, upon selecting the antennas of interest, shall indicate to the initiator the Nr index 902 for reduced dimension CSI feedback using, for example, the sensing measurement report frame 900. Nr index 902 may be configured to indicate the reduced number of rows which are being reported to the initiator. Further, Presence Bit field 904 may be used to indicate the presence of reduced dimension indices (e.g. Nr, Nc) by setting the values of 2 bits in the Presence Bit field 904. The 2-bit values may be set based on table 906, wherein ‘00’ indicates that Nc and Nr are not reduced, ‘01’ indicates that only Nr is reduced, ‘10’ indicates that only Nc is reduced, and ‘11’ indicates that both Nc and Nr are reduced. For reduced antenna reporting, the Nr value chosen by the responder shall not be same as the original Nr value.

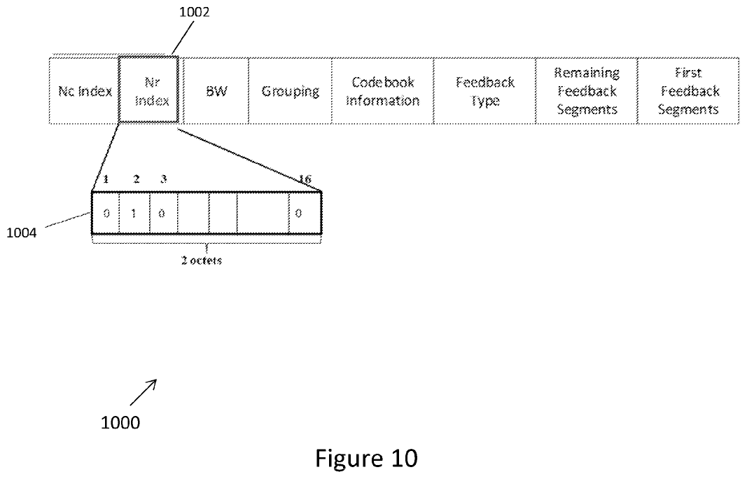

Alternatively, the responder may indicate an antenna bitmap for which reduced CSI is being reported to the initiator in a control frame. For example, in control frame 1000 of FIG. 10, Nr Index subfield 1002 may be presented in a form of a bitmap 1004 comprising 2 octets, each bit of a total of 16 bits representing an antenna, wherein a value of ‘1’ indicates that an associated antenna is being reported. Thus, if all bits are ‘1’, it means that all 16 antennas are being reported.

The CSI matrix for each reported subcarrier requires (3+2*Nb*Nr*Nc) bits. By using reduced dimension CSI feedback, a responder can advantageously reduce the feedback size by reporting only antennas of interest. In such a case, the reduced CSI feedback may be given by equation Ns*(3+2*Nb*Nc*Nr′) bits, wherein Ns is the number of subcarriers for a given bandwidth and Nr′ is the number of antennas for which CSI is reported. In cases where only reference antenna is being reported, the feedback size can be given by Ns*(2*Nb*Nc*Nr′) bits, such that the 3-bits scaling can advantageously be eliminated.

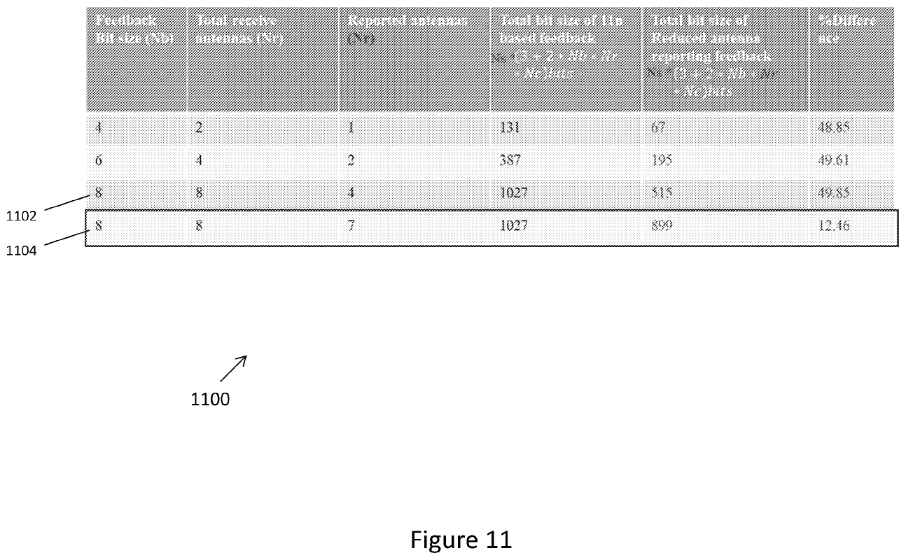

Table 1100 of FIG. 11 shows the feedback reduction which can be achieved by reporting antennas of interest in a case of 20 MHz bandwidth. In this example, Ns=56 for 20 MHz bandwidth. Highlighted row 1104 shows, in higher order MIMO systems, just by reporting one less antenna a feedback size compression of almost 12.5% is achieved. There can be cases where only half of the antennas present on the receivers are reported (for example, in row 1102, wherein the receiver has 8 receive antennas but only 4 are reported, a gain of ˜50% is achieved by reduced dimension CSI feedback. Similarly, Nc can also be reduced as Nr, the procedure remains the same and both Nr and Nc reduction can be done together as well.

To perform Nc reduction at a responder, the responder based on received CSI from different spatial streams select a reference spatial stream. The reference may be the receive chain with the highest SNR. The responder, upon selecting reference antenna, performs distance calculation between CSI values from spatial streams other than the reference spatial stream. If the distance is greater than the threshold, then the antenna is selected to be reported, otherwise the antenna's CSI is not reported. For WLAN Sensing use cases, it is often possible that CSI from all antennas is not relevant. Therefore, reporting only antennas of interest may help reduce bloated feedback transmission time.

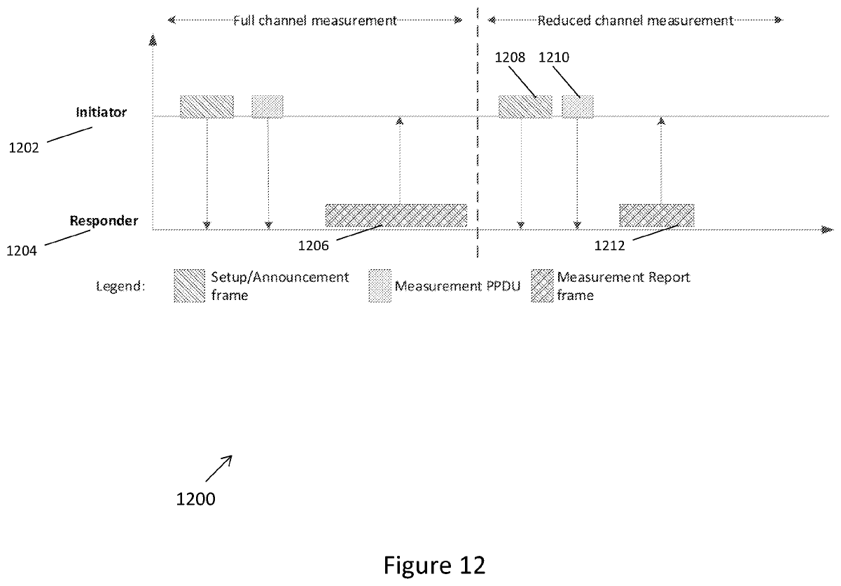

In an embodiment E2, an initiator may indicate the number of antennas for which it requires CSI feedback. Referring to illustration 1200 of FIG. 12, initiator 1202 may select a number of antennas (e.g. elements of a CSI matrix for which CSI is solicited) for which feedback is required based on full channel measurement e.g. from measurement report frame 1206 received from responder 1204. The initiator 1202 based on reception of full channel measurement from the responder 1204 may select antennas for which it wants to solicit the CSI feedback, and indicate the Nr and Nc index in a frame such as, for example, an NDP announcement frame 1208. The initiator 1202 may thus generate a NDP frame 1210 indicating the subset of elements of the CSI matrix for which CSI is solicited. The NDPA frame 1208 may indicate for example, Nc and Nr for which it wants to solicit CSI feedback from the responder 1204. The responder 1204 may perform measurement over the receive antennas, transmit antennas, or combination of receive and transmit antennas as indicated in the NDPA frame 1208 and respond in the report frame 1202. Alternatively, the initiator 1202 may receive a feedback report from the responder 1204 with reduced dimension as described in embodiment E1, then transmit NDPA frame 1208 indicating the same reduced Nr and Nc that were indicated in the feedback report. The responder may perform measurements over the indicated reduced Nr and Nc and transmit feedback report 1212 to the initiator. The initiator can obtain reduced CSI feedback report consistently on the same antennas and utilize temporal variation of the CSI values that are essential for performing sensing algorithms.

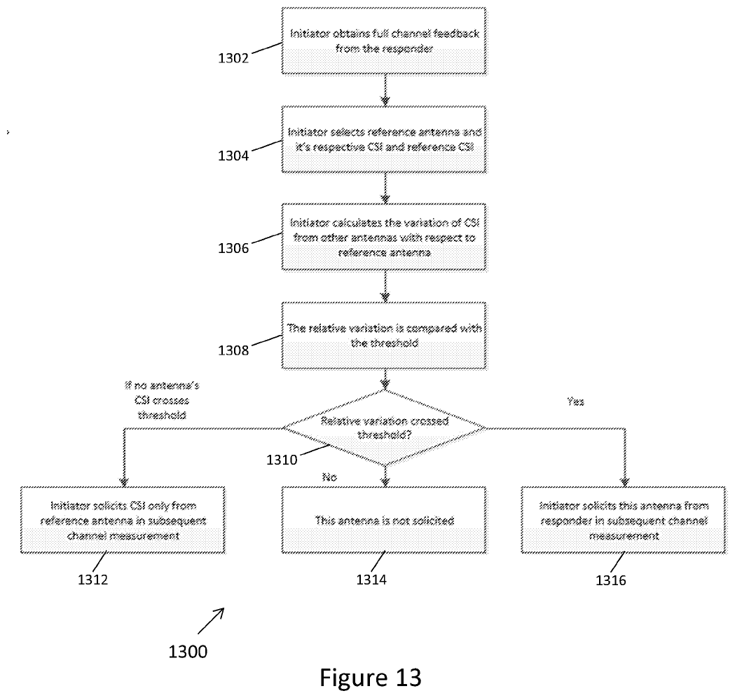

FIG. 13 depicts an example flowchart of an antenna selection procedure according to embodiment E2. At step 1302, an initiator obtains full channel feedback from a responder. At step 1304, the initiator selects a reference antenna and its respective CSI as reference CSI. At step 1306, the initiator calculates the variation of CSI from other antennas with respect to the reference CSI of the reference antenna. At step 1308, the relative variation is compared with a threshold. At step 1310, it is determined whether the relative variation crossed the threshold. If this is the case, the process proceeds to step 1316 wherein the initiator solicits the associated antenna from the responder in a subsequent channel measurement. Otherwise, the process proceeds to step 1314 wherein the associated antenna is not solicited. If it is determined that there are no antennas' CSI that crossed the threshold, the process proceeds to step 1312 wherein the initiator solicits CSI only from the reference antenna in a subsequent channel measurement.

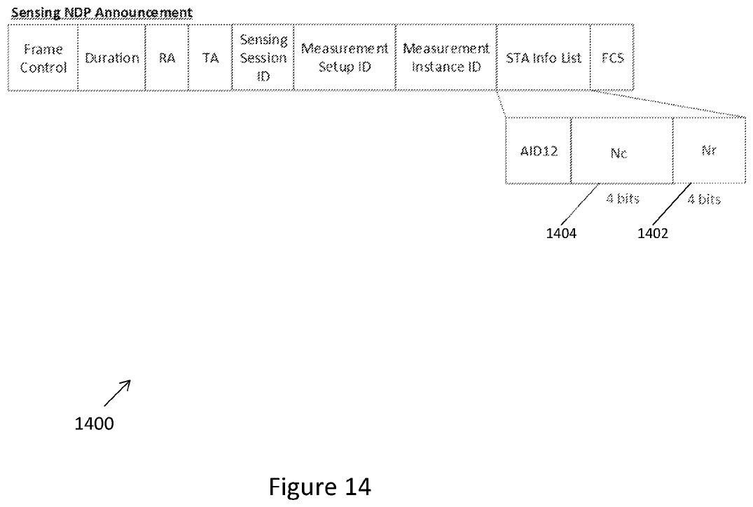

FIG. 14 depicts an example illustration of a sensing NDP announcement frame 1400 according to embodiment E2 which may be transmitted by an initiator to a responder to indicate reduced CSI dimensions. For example, Nr index field 1402 (4-bits) may be configured based on a selected antenna to indicate the Nr index for which feedback is required. Nc index field 104 (4-bits) may also be configured based on a selected antenna to indicate Nc index for which feedback is required.

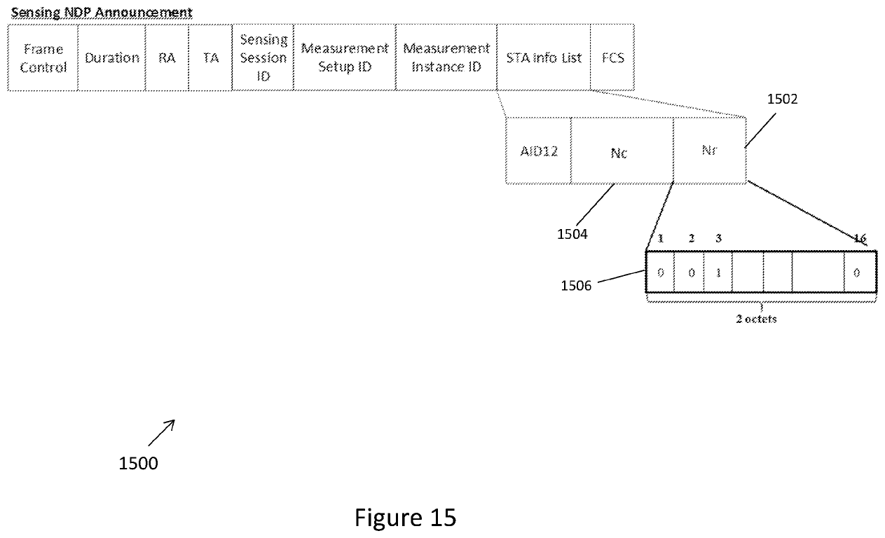

Alternatively, the initiator may use an antenna bitmap for indicating to the responder from which antennas the initiator wants to solicit CSI feedback. As shown in sensing NDP announcement frame 1500 of FIG. 15, Nr index field 1502 may be configured in a form of a bitmap 1506 comprising 2 octets, each bit representing an antenna of total 16 antennas. For example, if only the third bit of the bitmap is ‘1’, it may mean that only the third antenna is being solicited by the initiator. If all bits are ‘1’, it may then mean that all 16 antennas are being solicited. Similarly, Nc index field 1504 can also be represented using a bitmap in the same manner as Nr index field 1502.

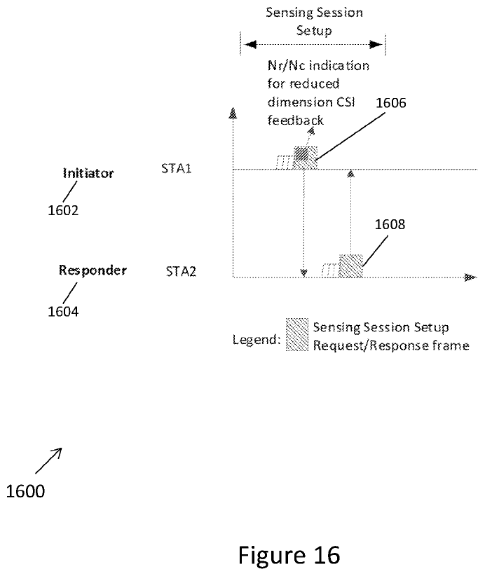

FIG. 16 depicts an example illustration 1600 of a sensing session setup according to embodiment E2. Sensing initiator 1602 and responder 1604 may negotiate Nr and Nc indexes for reduced dimension CSI feedback (e.g. via transmission of sensing session setup request frame 1606 from initiator 1602 to responder 1604 and sensing session setup response frame 1608 from responder 1604 to initiator 1602) during the sensing session setup. The sensing initiator 1602 may have multiple sensing sessions and each sensing session may be conducted pairwise with sensing responder 1604.

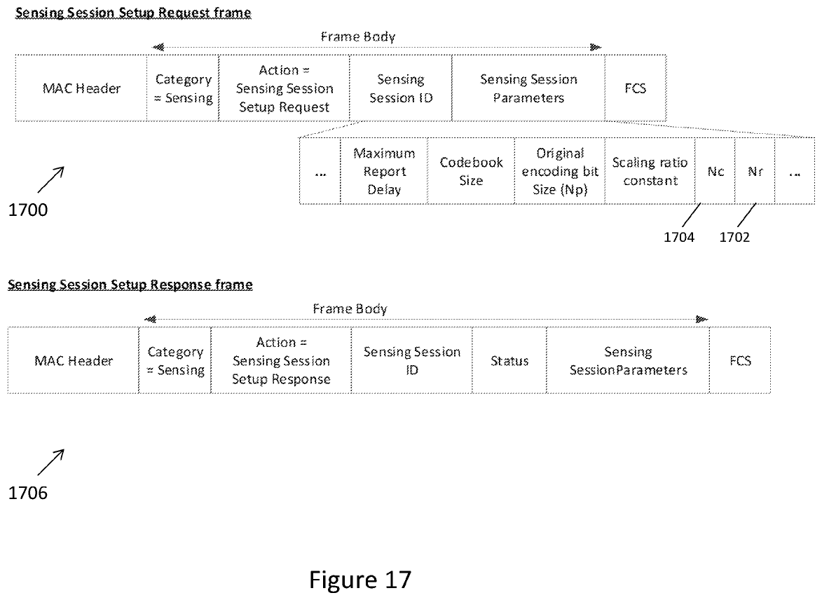

FIG. 17 depicts an example illustration of a sensing session setup request frame 1700 and response frame 1706 according to embodiment E2, which may be used to negotiate Nr and Nc indexes for reduced dimension CSI feedback in, for example, the sensing session setup of FIG. 16. For example, Nc index field 1704 and Nr index field 1702 may be configured as indexes or bitmap as similarly discussed in FIGS. 9, 10, 14 and 15 for the negotiation.

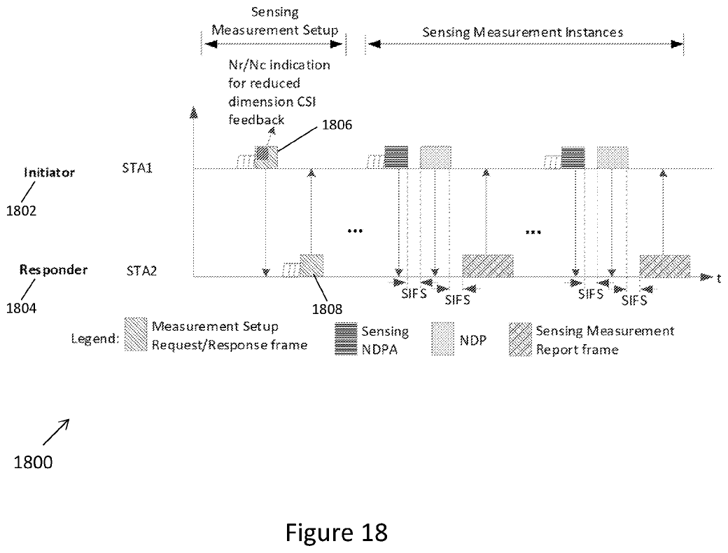

Another method to indicate the Nc, Nr index is to announce the Nc, Nr index during a sensing measurement setup. FIG. 18 depicts an example illustration 1800 of a sensing measurement setup according to embodiment E2. Sensing initiator 1802 and responder 1804 may negotiate Nr and Nc indexes for reduced dimension CSI feedback (e.g. via transmission of sensing measurement setup request frame 1806 from initiator 1802 to responder 1804 and sensing measurement setup response frame 1808 from responder 1804 to initiator 1802) during the sensing measurement setup.

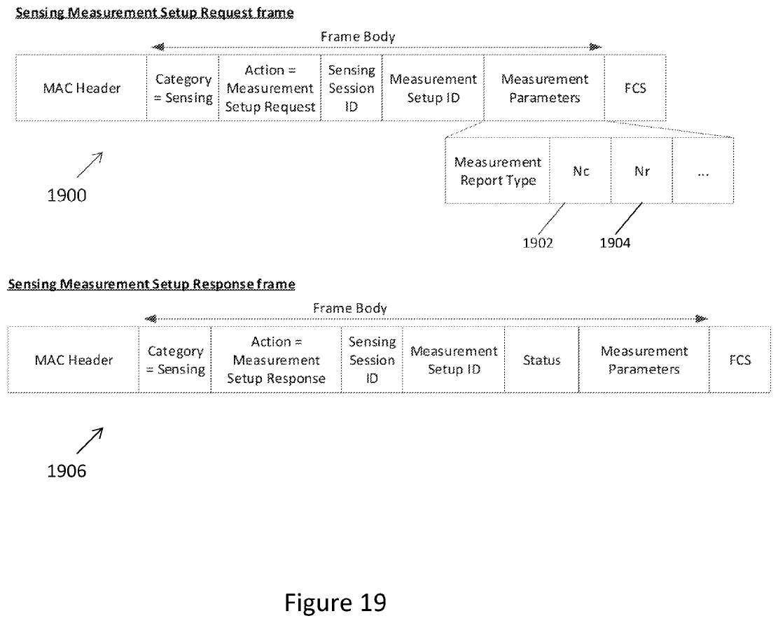

Nc and Nr parameters for reduced dimension CSI feedback can be negotiated during the sensing measurement setup phase. FIG. 19 depicts an example illustration of a sensing measurement setup request frame 1900 and sensing measurement setup response frame 1906 according to an embodiment E2, which may be used to negotiate Nr and Nc indexes for reduced dimension CSI feedback in, for example, the sensing measuring setup of FIG. 18. For example, Nc index field 1902 and Nr index field 1904 may be configured as indexes or bitmap as similarly discussed in FIGS. 9, 10, 14 and 15 for the negotiation. The Nc and Nr values can be signaled as Nc and Nr index respectively or as a bitmap of antennas for which CSI is to be solicited. Negotiating Nc and Nr parameters for reduced dimension CSI feedback during sensing measurement setup may be more flexible than negotiating Nc, Nr indexes during sensing session setup which can only be pairwise per session.

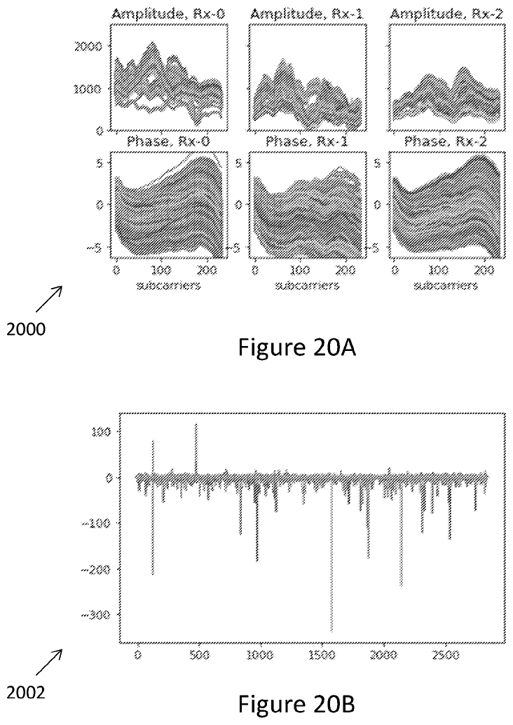

In an embodiment E3-1, a responder may calculate a ratio of CSI to be reported by selected antennas. The responder may perform a mathematical division on the CSI of different antennas of a device and feedback the CSI ratio as feedback to the initiator. For example, FIG. 20A shows example graphs 2000 depicting CSI from 3 different antennas of a receiver, while FIG. 20B shows an example graph 2002 depicting division operation applied to CSI from first and second antennas as shown in FIG. 20A. The responder may perform CSI ratio with all antennas of the responder, choosing 1 antenna as reference, or perform CSI ratio for selected antennas which are chosen for reduced dimension CSI feedback.

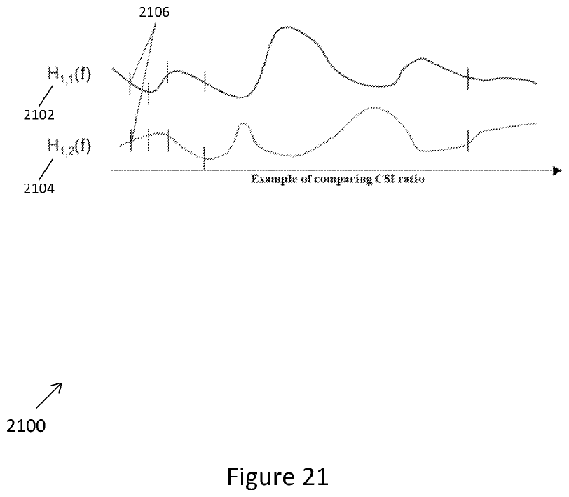

The responder upon receiving the Measurement PPDU obtains CSI for all antennas. The responder may compute the CSI based on a scenario chosen for CSI ratio calculation. FIG. 21 depicts an example illustration of how CSI ratio may be compared according to embodiment E3-1. For example, if CSI ratio is to be computed for all antennas without reduced dimension CSI feedback, and an antenna with highest SNR is chosen as reference antenna (wherein reference antenna CSI is H_{1,1}(f) 2102), CSI ratio may be computed as:

$$CSI ratio = \frac{H 1 , 1 ( f )}{H 1 , 2 ( f )} .$$

CSI values 2106 are usually in the form of I and Q and represented as I+jQ. Therefore, where H_{1,1}(f) 2102 and H_{1,2}(f) 2104 are in the form of H_{1,1}(f)=a+ib and H_{1,2}(f)=x+iy respectively, CSI ratio can be determined as:

$$CSI ratio = \frac{a + i b}{x + i y} * \frac{x - i y}{x - i y} = \frac{( a x + b y ) + i ( b x - a y )}{{x}^{2} + {y}^{2}} = c + i d ,$$

wherein the resultant ratio is also a complex number. It will be appreciated that the CSI matrix encoding remains the same as in 802.11n for such complex calculations for CSI ratio.

The responder may perform CSI ratio calculation based on antennas of interest where antenna selection is performed as described earlier. Alternatively, the responder may select the antenna with highest SNR and choose the antenna with highest SNR as reference and perform complex division with CSI values for each subcarrier for the remaining antennas of the responder.

Alternatively, a CSI ratio may be computed as:

$$CSI ratio = \frac{H 1 , 2 ( f )}{H 1 , 1 ( f )} = H 1 , 2 ( f ) \times \frac{1}{H 1 , 1 ( f )} ,$$

where the reference CSI value is the denominator of division. This variation may reduce computation complexity as number of division operation is reduced by reusing the reciprocal value of the reference antenna (1/H1,1(f)) when computing the CSI ratio values for more than two reported antennas. Alternatively, a responder may calculate a Scaled CSI ratio with the following equation: Scaled CSI ratio=H1,1(f)×(H1,2(f))*=(ax+by)+i (bx−ay), wherein * denotes a complex conjugate. A Scaled CSI ratio is a CSI ratio scaled by the squared amplitude of H_{1,1}(f). The value is different scale than the CSI ratio, but keeps the angle information of the CSI ratio that may be used for sensing application. Computation of a Scaled CSI ratio may reduce computation complexity as it does not include division. The responder may transmit the Scaled CSI ratio and reference CSI values (H_{1,1}(f)) or its amplitude value to an initiator. The initiator may recover a CSI ratio by performing scaling over the Scaled CSI ratio using the amplitude of the reference CSI values.

If a responder performs reduced dimension CSI feedback, the same antenna selection rules may be applied as described in embodiment E1. The responder upon selecting antennas of interest performs CSI ratio on selected antennas and reports the CSI ratio as feedback. There may be some cases where the denominator of the CSI ratio is a very small number compared to the numerator which will lead to CSI ratio tending to infinity. To eliminate this issue, the resultant CSI ratio is treated with a sigmoid function (for example, arctan or Euler's function) as a threshold function to wrap the values. For example, if arctan is used, the resultant values will be ranging between +1 to −1 and 2's compliment encoding is needed. If thresholding function like Euler's function is used, it can be encoded using unsigned integer, therefore saving 1 bit in the encoding. If the CSI ratio is not treated with sigmoid function, it can be decoded by multiplying the received CSI ratio with the reference value to reconstruct the original CSI. In case when the CSI ratio is treated with sigmoid, the initiator may perform reverse sigmoid operation on the received CSI ratio and then multiply the CSI ratio with the reference CSI. If all antennas are being reported, CSI ratio leads to reducing the CSI matrix dimension. By having one less antenna with complete information when reduced dimension CSI matrix is considered, the reduced CSI matrix dimension is reduced further by 1 order. This method of CSI reporting is advantageously useful in environment detection as it may directly be used without any further processing.

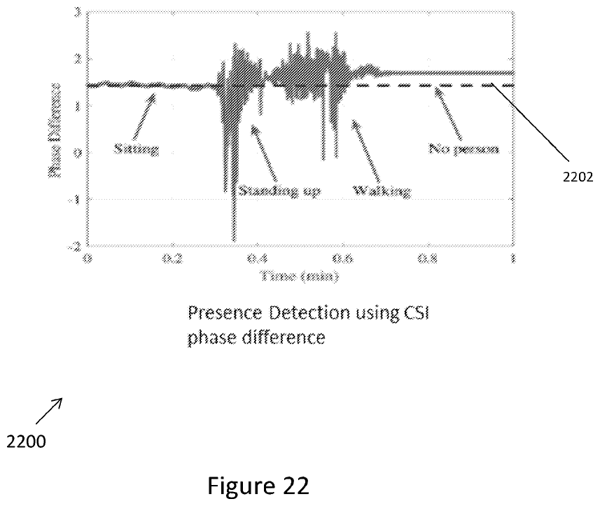

In an embodiment E3-2, CSI difference can be used to determine environment for presence detection. FIG. 22 shows an example graph 2200 depicting presence detection using CSI phase difference according to embodiment E3-2. The dashed line 2202 describes the threshold for presence detection. Phase difference can be calculated by complex numbered subtraction, and will result in a sinusoidal pattern if someone is present, or a straight line otherwise. The threshold for presence detection can be computed using mean absolute deviation of the CSI values per antenna. The responder may perform complex number subtraction on CSI values per packet in static environment with

$$Phase difference = \frac{( z 11 - z 21 ) + ( z 12 - z 22 ) + … + ( zkl - z ( k + 1 ) l )}{n}$$

over a sliding window, wherein zkl is the CSI for the kth antenna and lth subcarrier, and n being the total number of subcarriers.

CSI may be obtained per antenna per subcarrier as I and Q values and expressed as z=I+jQ. The CSI difference is expressed as CSI difference=z1−z2. This equation will result in another complex value which is the difference of CSI between two antennas for a given subcarrier. When CSI difference is calculated for reduced dimension CSI feedback, the antennas are selected as described in embodiment E1 and CSI difference is computed between CSI values of selected antennas which are to be reported. Encoding and decoding of CSI difference follows the same encoding procedure as 802.11n. If all antennas are being reported, CSI difference leads to reducing the CSI matrix dimension. By reducing one less antenna with complete information when reduced dimension CSI matrix is considered, the reduced CSI matrix dimension is reduced further by 1 order. This method of CSI reporting is advantageously useful in presence detection, and may directly be used without any further processing.

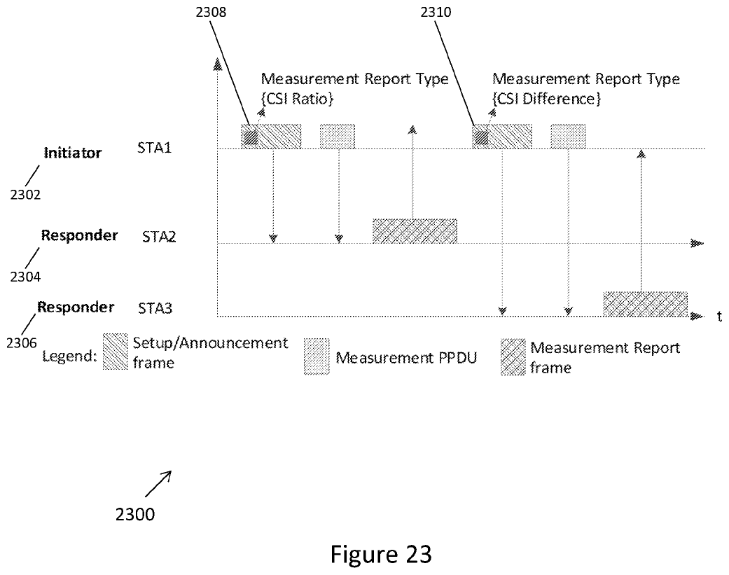

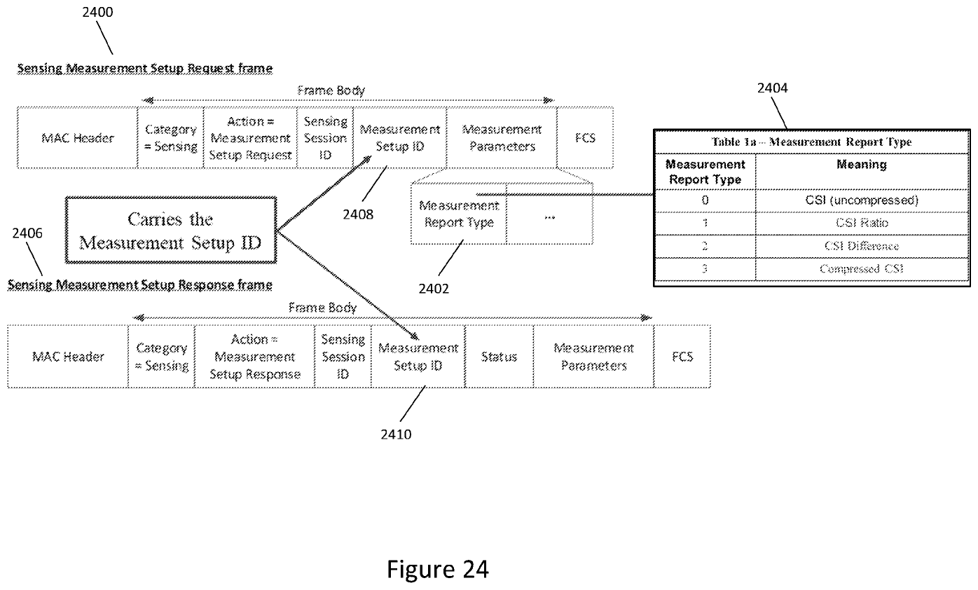

FIG. 23 depicts an example illustration of a measurement setup procedure for CSI ratio or difference according to embodiment E3-2. Initiator 2302 may indicate measurement report type being a CSI ratio in a setup/announcement frame 2308 to a responder STA2 2304, and may indicate a measurement report type being a CSI difference in a setup/announcement frame 2310 to responder STA3 2306. Further referring to sensing measurement setup request frame 2400 and sensing measurement setup response frame 2406 of FIG. 24, the measurement report type may be indicated in measurement report type field 2402. The measurement report type field 2402 may indicate values based on table 2404 depicting possible values with their respective meanings. For example, the measurement report type field 2402 may indicate a value of ‘1’ for CSI ratio and ‘2’ for CSI difference. Measurement setup ID field 2408 of sensing measurement setup request frame 2400 and measurement setup ID field 2410 of sensing measurement setup response frame 2406 shall carry the same measurement setup ID to indicate that both are for the same sensing measurement setup.

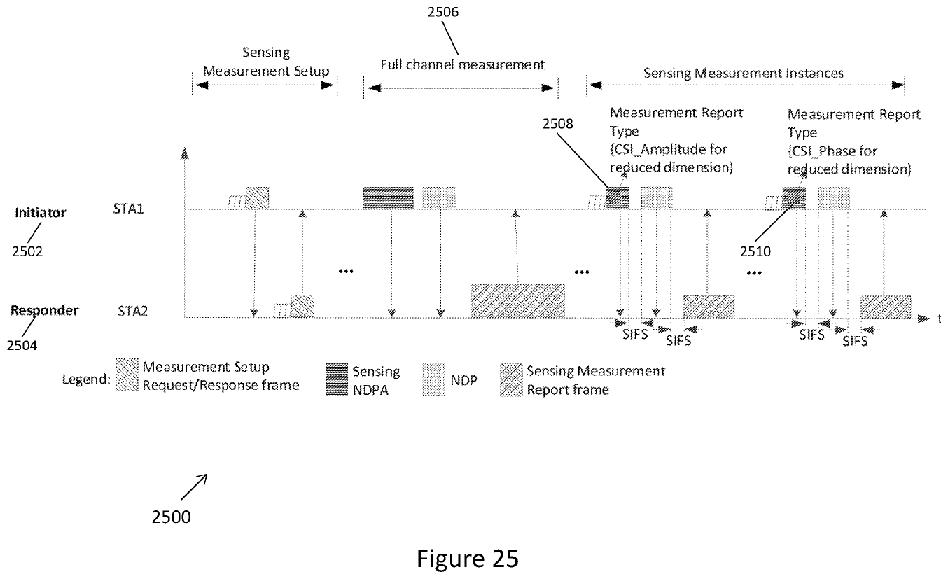

In an embodiment E4, an initiator may choose to solicit amplitude or phase from reduced antenna from a responder based on application requirements. FIG. 25 depicts an example illustration of a sensing measurement setup procedure according to embodiment E4. Based on the full channel measurement (e.g. obtained from full channel measurement phase 2506), the initiator 2502 may select antennas for which it wants to solicit amplitude information or phase information from the responder. For example, the initiator 2502 may solicit amplitude information by transmitting a sensing NDPA 2508 (e.g. indicating measurement report type as ‘amplitude’) to responder 2504, or solicit phase information by transmitting a sensing NDPA 2510 (e.g. indicating measurement report type as ‘phase’) to responder 2504. The initiator 2502 can also indicate the antennas for which amplitude or phase information is solicited as described in embodiment E1.

Alternatively, during the full channel measurement 2506, the responder 2504 may indicate the bitmap of antennas for which the CSI fluctuates significantly as compared to the reference antenna's CSI value. The initiator 2502 in the subsequent measurement instance may then solicit CSI from the antennas indicated by the responder 2504.

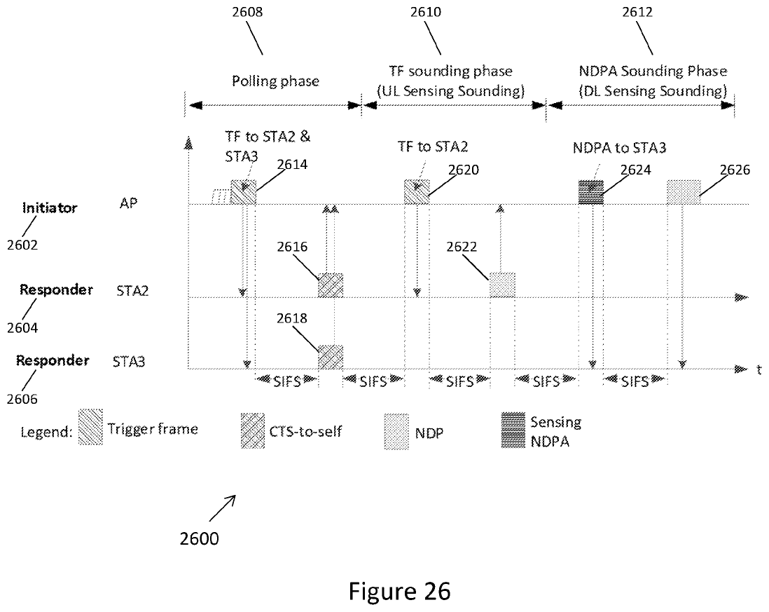

In an embodiment E5, instead of using feedback-based sensing measurements, when the initiator is an AP, it is also possible that Trigger based (TB) sensing measurement is used instead. FIG. 26 depicts an example illustration 2600 of a trigger-based sensing measurement setup procedure according to embodiment E5. A TB sensing measurement instance may include a polling phase, a trigger frame (TF) sounding phase and a NDPA sounding phase. In polling phase 2608, AP 2602 sends a trigger frame 2614 to check the availability of STAs. If a STA is available, it responds with a clear-to-send (CTS)-to-self frame. For example, trigger frame 2614 is sent to STA2 2604 and STA3 2606. Since both STAs are available, STA2 2604 sends CTS-to-self frame 2616 to AP 2602 and STA3 sends CTS-to-self frame 2618 to AP 2602. In a TF sounding phase, the AP transmits a trigger frame to solicit NDP transmission(s) from STA(s) followed by transmission of an NDP by STA(s) at an SIFS after receiving the trigger frame. The NDP is used by AP to measure the uplink (UL) channel. For example, in TF sounding phase 2610, AP 2602 sends a trigger frame 2620 to STA2 2604. In response, STA2 2604 transmits a NDP frame 2622 to AP 2602. AP 2602 uses the NDP frame 2622 from STA2 2604 to measure the UL channel between STA2 2604 and AP 2602. In a NDPA sounding phase, the AP transmits a NDP Announcement (NDPA) frame followed by the transmission of a NDP at a SIFS after the transmission of the NDPA frame. The NDP is used by non-AP STA(s) to measure the downlink (DL) channel. For example, in NDPA sounding phase 2612, AP 2602 transmits a NDPA frame 2624, followed by a transmission of NDP frame 2626 to STA3 2606. STA3 2606 uses the NDP frame 2626 from AP 2602 to measure the DL channel between AP 2602 and STA3 2606.

In TB sensing measurements, STA(s) do not need to send Sensing Measurement Report frames to the peer STA(s) and instead perform the sensing measurements for their own use (based on the received NDP(s)). In this case the sensing measurement results are passed up to upper layer sensing applications. The Sensing App in the Initiator may use the following MLME primitive to initiate a TB sensing measurements, the MLME primitive further indicating a ‘Measurement Report Type’:

```
MLME-TB-Sensing.request(
  Responder MAC Address,
  Member ID List,
  Sensing Session ID,
  Measurement Setup ID,
  Measurement Instance ID,
  Number of Streams,
  Bandwidth,
  Measurement Report Type,
  NDPA Information,
  )
```

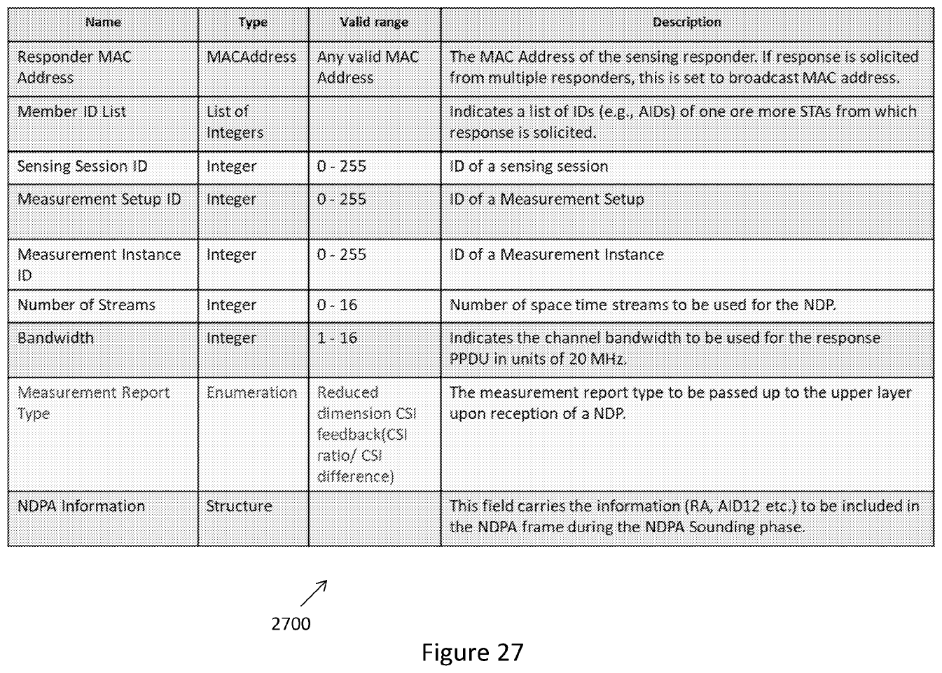

Upon receipt of this primitive, the MLME initiates a TB sensing measurement session and constructs a Trigger frame for transmission to one or more sensing responders. Various example parameters that may be used in a MLME-TB-Sensing.request ( ) primitive are shown in example table 2700 of FIG. 27. For example, Measurement Report Type may be indicated as Reduced dimension CSI feedback (CSI Ratio or CSI difference) for indicating the measurement report type to be passed up to the upper layer upon reception of a NDP.

Further, upon receiving NDP(s), the sensing measurement results are passed up to upper layer sensing applications using the following MLME primitive also indicating ‘Measurement Report Type’:

```
MLME-TB-Sensing.confirm(
  MAC Address,
  Member ID,
  Sensing Session ID,
  Measurement Setup ID,
  Measurement Instance ID,
  Bandwidth,
  Measurement Report Type,
  NumberOfSubcarriers_Ns,
  NumberOfColumns_Nc,
  NumberOfReceiveChains_Nr,
  NumberOfBitsPerElement_Nb,
  FeedbackMatrix,
  SNRList
  )
```

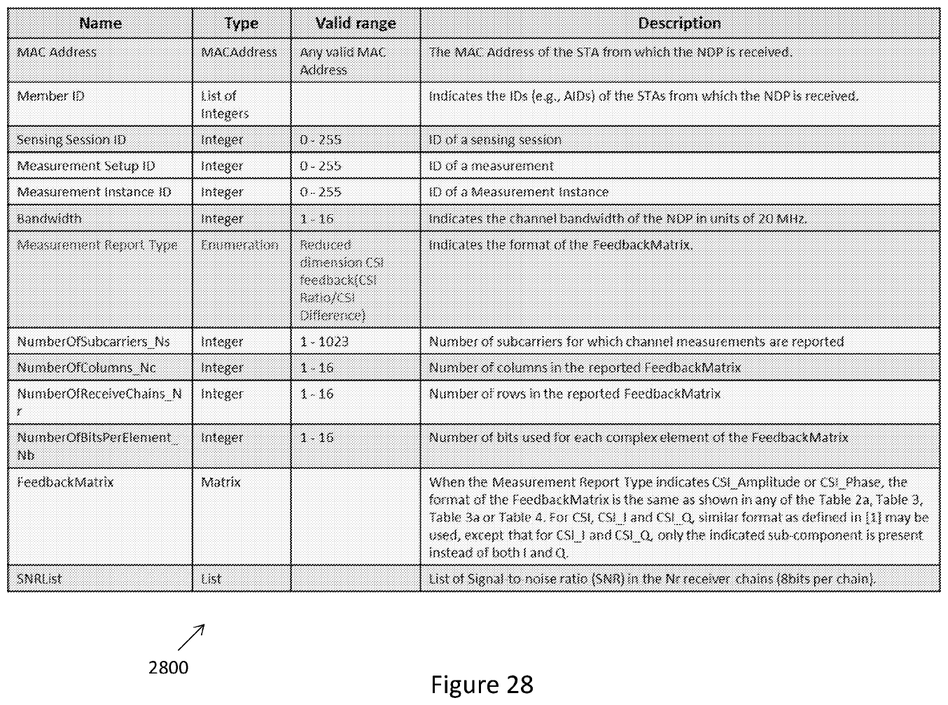

The primitive is generated upon receipt of a NDP, to notify a station management entity (SME) of the results of channel measurement. Various example parameters that may be used in a MLME-TB-Sensing.confirm ( ) primitive are shown in example table 2800 of FIG. 28. For example, Measurement Report Type may be indicated as Reduced dimension CSI feedback (CSI Ratio or CSI difference) for indicating the format of the feedback matrix.

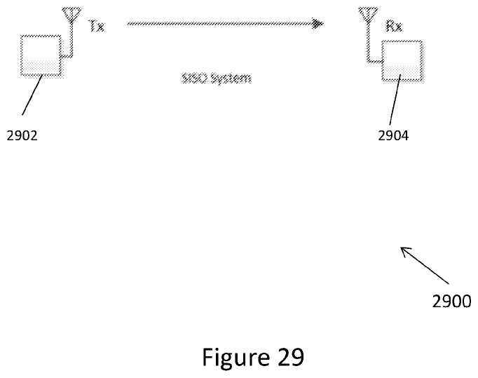

In an embodiment E6, it is possible for SISO systems to be used for performing WLAN sensing. FIG. 29 depicts an example illustration of a SISO system 2900 consisting of single antenna systems on both transmitter side 2902 and receiver side 2904 respectively. For such cases, a single stream is reported as CSI feedback which is currently restricted in the 802.11 specifications. Therefore, the specifications should allow Nr=1 and Nc=1 sounding for sensing. WLAN sensing can be performed on single antenna systems like (Raspberry PI), hence reporting of single stream should be allowed in the specifications.

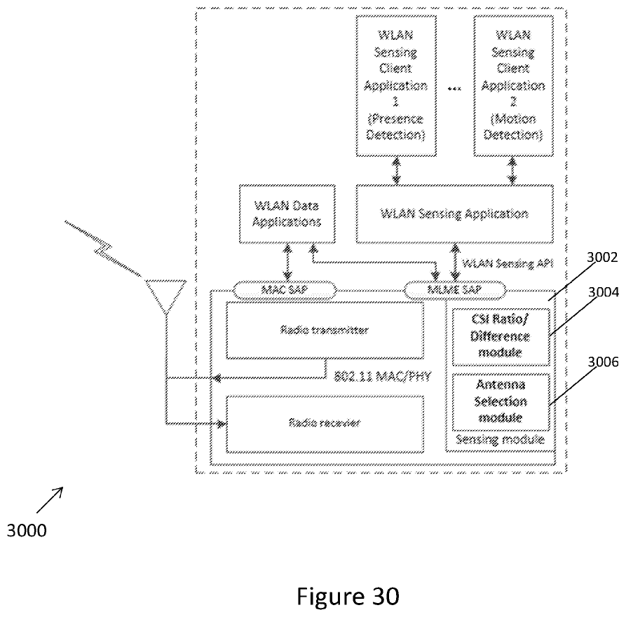

FIG. 30 depicts a schematic diagram for a responder 3000 in accordance with various embodiments. The responder 3000 may be configured to communicate with an initiator for sensing measurements and may comprise a sensing module 3002 configured for performing functions required for such sensing measurements. The sensing module 3002 may comprise a CSI ratio/difference module 3004 that may be configured to perform complex valued division or subtraction on CSI values of a plurality of elements or a selected subset of elements to reduce CSI feedback overhead. The sensing module 3002 may further comprise an antenna selection module 3006 that may be configured to measure CSI based on a received PPDU, and selects a subset of elements from a plurality of elements of a CSI matrix based on the measured CSI, wherein each element represents the CSI measured at a receive antenna of a first communication apparatus (e.g. the responder 3000) corresponding to a transmit antenna of a second communication apparatus (e.g. the initiator). The sensing module 3002 may have an inbuilt memory of its own that may be used to store the PPDU formats and relevant information for performing channel measurement, such that channel measurement can be performed by the responder 3000 without any indication from or involvement of the initiator.

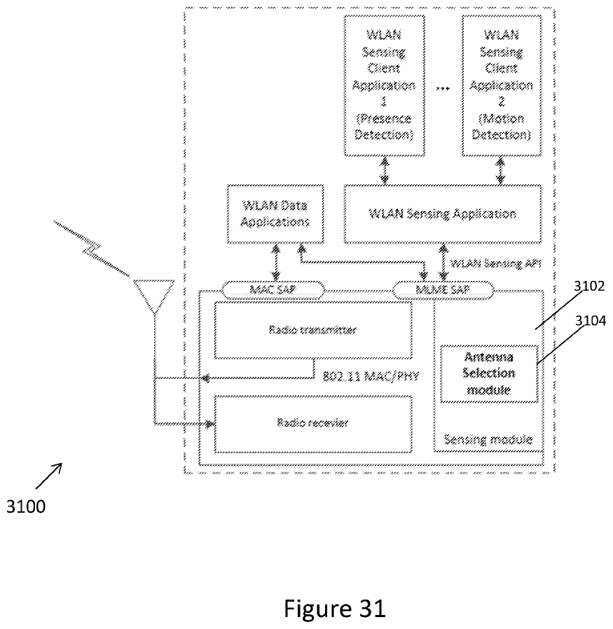

FIG. 31 depicts a schematic diagram for an initiator 3100 in accordance with various embodiments. The initiator 3100 may be configured to communicate with a responder (for example responder 3000) for sensing measurements and may comprise a sensing module 3102 that may be configured for performing functions required for such sensing measurements. The sensing module 3102 may further comprise an antenna selection module 3104 that may be configured to indicate, in a frame, a subset of elements of a CSI matrix for which CSI is solicited, the frame being generated for transmission to a responder.

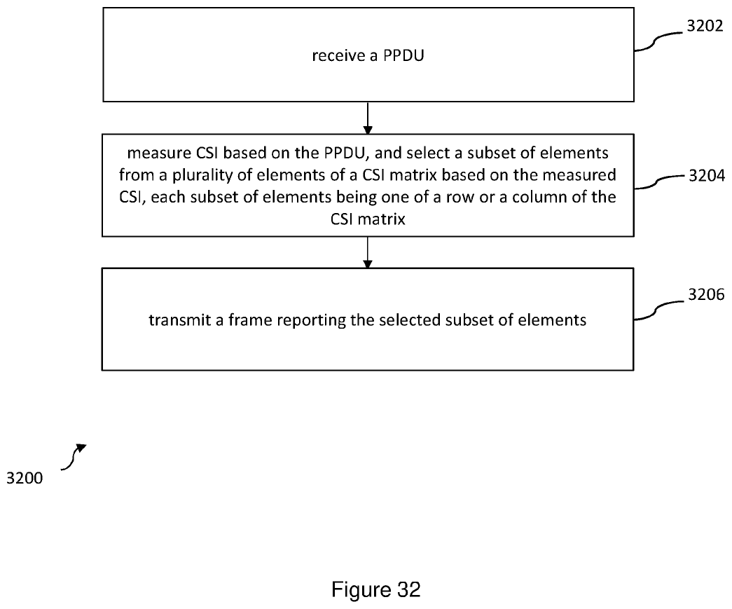

FIG. 32 shows a flow diagram 3200 illustrating a communication method according to various embodiments. At step 3202, a PPDU is received. At step 3204, CSI is measured based on the PPDU, and a subset of elements is selected from a plurality of elements of a CSI matrix based on the measured CSI, wherein each element represents the CSI measured at a receive antenna of a first communication apparatus corresponding to a transmit antenna of a second communication apparatus. At step 3206, a frame reporting the selected subset of elements is transmitted.

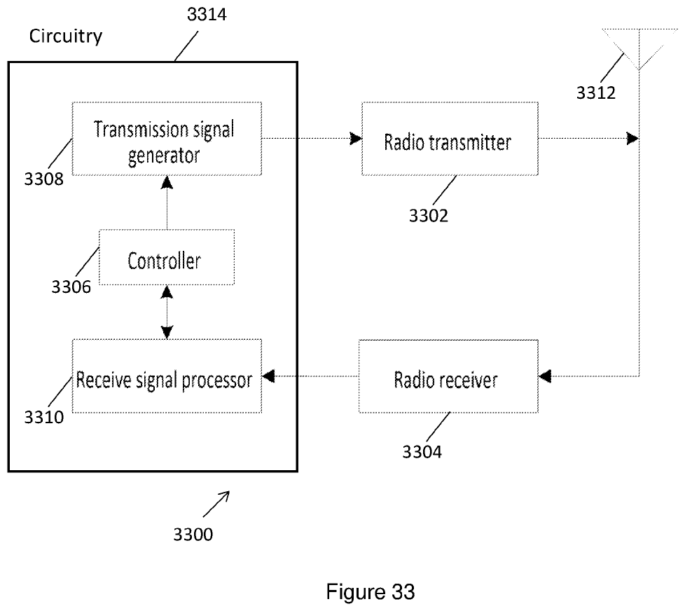

FIG. 33 shows a schematic, partially sectioned view of a communication apparatus 3300 that can be implemented for reduced dimension CSI feedback in accordance with the embodiments E1-E6. The communication apparatus 3300 may be implemented as an STA or AP according to various embodiments.

Various functions and operations of the communication apparatus 3300 are arranged into layers in accordance with a hierarchical model. In the model, lower layers report to higher layers and receive instructions therefrom in accordance with IEEE specifications. For the sake of simplicity, details of the hierarchical model are not discussed in the present disclosure.

As shown in FIG. 33, the communication apparatus 3300 may include circuitry 3314, at least one radio transmitter 3302, at least one radio receiver 3304 and multiple antennas 3312 (for the sake of simplicity, only one antenna is depicted in FIG. 33 for illustration purposes). The circuitry may include at least one controller 3306 for use in software and hardware aided execution of tasks it is designed to perform, including control of communications with one or more other devices in a wireless network. The at least one controller 3306 may control at least one transmission signal generator 3308 for generating frames to be sent through the at least one radio transmitter 3302 to one or more other STAs or APs and at least one receive signal processor 3310 for processing frames received through the at least one radio receiver 3304 from the one or more other STAs or APs. The at least one transmission signal generator 3308 and the at least one receive signal processor 3310 may be stand-alone modules of the communication apparatus 3300 that communicate with the at least one controller 3306 for the above-mentioned functions. Alternatively, the at least one transmission signal generator 3308 and the at least one receive signal processor 3310 may be included in the at least one controller 3306. It is appreciable to those skilled in the art that the arrangement of these functional modules is flexible and may vary depending on the practical needs and/or requirements. The data processing, storage and other relevant control apparatus can be provided on an appropriate circuit board and/or in chipsets.

In various embodiments, when in operation, the at least one radio transmitter 3302, at least one radio receiver 3304, and at least one antenna 3312 may be controlled by the at least one controller 3306. Furthermore, while only one radio transmitter 3302 is shown, it will be appreciated that there can be more than one of such transmitters.

In various embodiments, when in operation, the at least one radio receiver 3304, together with the at least one receive signal processor 3310, forms a receiver of the communication apparatus 3300. The receiver of the communication apparatus 3300, when in operation, provides functions required for sensing operations. While only one radio receiver 3304 is shown, it will be appreciated that there can be more than one of such receivers.

The communication apparatus 3300, when in operation, provides functions required for reduced dimension CSI feedback. For example, the communication apparatus 3300 may be a first communication apparatus. The receiver 3304 may, in operation, receive a PPDU from a second communication apparatus. The circuitry 3314 may, in operation, measure CSI based on the PPDU, and select a first subset of elements from a plurality of elements of a CSI matrix, wherein each element represents the CSI measured at a receive antenna of the first communication apparatus corresponding to a transmit antenna of the second communication apparatus. The transmitter 3302 may, in operation, transmit a frame reporting the selected subset of elements to the second communication apparatus.

The first subset of elements may comprise one or more rows or one or more columns of the CSI matrix. Each row or column of the CSI matrix may be associated with each antenna of the first communication apparatus, respectively. The first and second communication apparatuses may be single antenna devices, and the first subset of elements may comprise only the reference elements.

The circuitry 3314 may be further configured to reduce the CSI matrix by removing a second subset of elements from the plurality of elements of the CSI matrix, and the transmitter 3302 may be further configured to transmit the frame reporting the reduced CSI matrix to the second communication apparatus. The circuitry 3314 may be further configured to select a second subset of elements as reference elements based on signal-noise-ratio (SNR) among the plurality of elements. The circuitry 3314 may be further configured to set a threshold CSI value based on the reference elements, compute and compare CSI value of each element excluding the reference elements in the plurality of elements with the threshold CSI value, and select the subset of elements based on the comparison. Each element in the selected subset of elements may have a CSI value that is higher than that of the threshold CSI value. The circuitry 3314 may be further configured to report only CSI values of the reference elements if no element has a CSI value that crosses the threshold CSI value based on the comparison.

The transmitter 3302 may be further configured to transmit a control frame reporting the selected subset of elements to the second communication apparatus. The control frame may report the selected subset of elements as a bitmap to the second communication apparatus.

The circuitry 3314 may be further configured to perform complex valued division on CSI values of the plurality of elements or the selected subset of elements to reduce feedback overhead. The circuitry 3314 may be further configured to perform complex valued subtraction on CSI values of the plurality of elements or the selected subset of elements to reduce feedback overhead.

The communication apparatus 3300 may be a second communication apparatus. The circuitry 3314 may, in operation, generate a frame indicating a subset of elements of a CSI matrix for which CSI is solicited. The transmitter 3302 may, in operation, transmits the frame to a first communication apparatus.

The frame may indicate that a CSI ratio or a CSI difference is to be measured and reported by the first communication apparatus to the second communication apparatus. The second communication apparatus may be an access point (AP), wherein the transmitter 3302 may be further configured to transmit a trigger frame to solicit NDP transmission from the first communication apparatus, and the receiver 3304 may, in operation, receive a NDP from the first communication apparatus. The circuitry 3314 may be further configured to measure CSI of an uplink channel based on the received NDP.

Further, the communication apparatus 3300 may be a second communication apparatus. The circuitry 3314 may, in operation, generate a frame indicating a subset of elements of a CSI matrix for which a component of the CSI matrix is solicited. The transmitter 3302 may, in operation, transmit the frame to a first communication apparatus. The component of CSI matrix solicited by the second communication apparatus may be an amplitude or a phase of the CSI matrix.

The present disclosure can be realized by software, hardware, or software in cooperation with hardware. Each functional block used in the description of each embodiment described above can be partly or entirely realized by an LSI such as an integrated circuit, and each process described in each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra-LSI depending on a difference in the degree of integration. However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing. If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred as a communication device.

Some non-limiting examples of such communication device include a phone (e.g., cellular (cell) phone, smart phone), a tablet, a personal computer (PC) (e.g., laptop, desktop, netbook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication device is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT)”.

The communication may include exchanging data through, for example, a cellular system, a wireless LAN system, a satellite system, etc., and various combinations thereof.

The communication device may comprise an apparatus such as a controller or a sensor which is coupled to a communication apparatus performing a function of communication described in the present disclosure. For example, the communication device may comprise a controller or a sensor that generates control signals or data signals which are used by a communication apparatus performing a communication function of the communication device.

The communication device also may include an infrastructure facility, such as a base station, an access point, and any other apparatus, device or system that communicates with or controls apparatuses such as those in the above non-limiting examples.

A non-limiting example of a station may be one included in a first plurality of stations affiliated with a multi-link station logical entity (i.e. such as an MLD), wherein as a part of the first plurality of stations affiliated with the multi-link station logical entity, stations of the first plurality of stations share a common medium access control (MAC) data service interface to an upper layer, wherein the common MAC data service interface is associated with a common MAC address or a Traffic Identifier (TID).

Thus, it can be seen that the present embodiments provide communication devices and methods for reduced dimension CSI feedback.

While exemplary embodiments have been presented in the foregoing detailed description of the present embodiments, it should be appreciated that a vast number of variations exist. It should further be appreciated that the exemplary embodiments are examples, and are not intended to limit the scope, applicability, operation, or configuration of this disclosure in any way. Rather, the foregoing detailed description will provide those skilled in the art with a convenient road map for implementing exemplary embodiments, it being understood that various changes may be made in the function and arrangement of steps and method of operation described in the exemplary embodiments and modules and structures of devices described in the exemplary embodiments without departing from the scope of the subject matter as set forth in the appended claims.

1. A first communication apparatus, comprising:
a receiver, which in operation, receives a physical layer protocol data unit (PPDU) from a second communication apparatus;
circuitry, which in operation, measures channel state information (CSI) based on the PPDU, and selects a first subset of elements from a plurality of elements of a CSI matrix, wherein each element represents the CSI measured at a receive antenna of the first communication apparatus corresponding to a transmit antenna of the second communication apparatus; and
a transmitter, which, in operation, transmits a frame reporting the selected subset of elements to the second communication apparatus.

2. The first communication apparatus of claim 1, wherein the first subset of elements comprises one or more rows or one or more columns of the CSI matrix.

3. The first communication apparatus of claim 2, wherein each row or column of the CSI matrix is associated with each antenna of the first communication apparatus, respectively.

4. The first communication apparatus of claim 2, wherein the first and second communication apparatuses are single antenna devices, and the first subset of elements comprises only the reference elements.

5. The first communication apparatus of claim 1, wherein the circuitry is further configured to reduce the CSI matrix by removing a second subset of elements from the plurality of elements of the CSI matrix, and the transmitter is further configured to transmit the frame reporting the reduced CSI matrix to the second communication apparatus.

6. The first communication apparatus of claim 1, wherein the circuitry is further configured to select a second subset of elements as reference elements based on signal-noise-ratio (SNR) among the plurality of elements.

7. The first communication apparatus of claim 6, wherein the circuitry is further configured to:
set a threshold CSI value based on the reference elements;
compute and compare CSI value of each element excluding the reference elements in the plurality of elements with the threshold CSI value; and
select the subset of elements based on the comparison.

8. The first communication apparatus of claim 7, wherein each element in the selected subset of elements has a CSI value that is higher than that of the threshold CSI value.

9. The first communication apparatus of claim 7, wherein the circuitry is further configured to report only CSI values of the reference elements if no element has a CSI value that crosses the threshold CSI value based on the comparison.

10. The first communication apparatus of claim 1, wherein the transmitter is further configured to transmit a control frame reporting the selected subset of elements to the second communication apparatus.

11. The first communication apparatus of claim 10, wherein the control frame reports the selected subset of elements as a bitmap to the second communication apparatus.

12. The first communication apparatus of claim 1, wherein the circuitry is further configured to perform complex valued division on CSI values of the plurality of elements or the selected subset of elements to reduce feedback overhead.

13. The first communication apparatus of claim 1, wherein the circuitry is further configured to perform complex valued subtraction on CSI values of the plurality of elements or the selected subset of elements to reduce feedback overhead.

14. A second communication apparatus, comprising:
circuitry, which in operation, generates a frame indicating a subset of elements of a CSI matrix for which CSI is solicited; and
a transmitter, which in operation, transmits the frame to a first communication apparatus.

15. The second communication apparatus of claim 14, wherein the frame indicates that a CSI ratio or a CSI difference is to be measured and reported by the first communication apparatus to the second communication apparatus.

16. The second communication apparatus of claim 14, wherein the second communication apparatus is an access point (AP), wherein the transmitter is further configured to transmit a trigger frame to solicit NDP transmission from the first communication apparatus, the second communication apparatus further comprising a receiver, which in operation, receives a null data packet (NDP) from the first communication apparatus.

17. The second communication apparatus of claim 16, wherein the circuitry is further configured to measure CSI of an uplink channel based on the received NDP.

18. A second communication apparatus, comprising:
circuitry, which in operation, generates a frame indicating a subset of elements of a CSI matrix for which a component of the CSI matrix is solicited; and
a transmitter, which in operation, transmits the frame to a first communication apparatus.

19. The second communication apparatus of claim 18, wherein the component of CSI matrix solicited by the second communication apparatus is an amplitude or a phase of the CSI matrix.

20. A communication method, comprising:
receiving a physical layer protocol data unit (PPDU);
measuring channel state information (CSI) based on the PPDU, and selecting a subset of elements from a plurality of elements of a CSI matrix based on the measured CSI, wherein each element represents the CSI measured at a receive antenna of a first communication apparatus corresponding to a transmit antenna of a second communication apparatus, and
transmitting a frame reporting the selected subset of elements.
